(19) United States
(12) Patent Application Publication
(10) Pub. No.: US 2025/0116084 A1
(43) Pub. Date: Apr. 10, 2025

(54) HOIST ROPE PROTECTION

(71) Applicant: Joy Global Surface Mining Inc, Milwaukee, WI (US)

(72) Inventors: Joseph J. Colwell, Hubertus, WI (US); John Von Helms, New Berlin, WI (US)

(21) Appl. No.: 18/907,524

(22) Filed: Oct. 5, 2024

Related U.S. Application Data
(60) Provisional application No. 63/588,558, filed on Oct. 6, 2023.

(51) Int. Cl. E02F 3/42; E02F 3/30; F16G 9/04

(52) U.S. Cl. CPC E02F 3/425; F16G 9/04; E02F 3/304; E02F 3/308

(57) ABSTRACT

A hoist system is provided for an industrial machine including a digging attachment supported for movement to excavate material. The hoist system includes a rope attachment device configured to be coupled to the digging attachment; a synthetic rope configured to extend between a hoist drum and the rope attachment device, at least a portion of the synthetic rope configured to be selectively wrapped onto the hoist drum; and a rope protector extending along an outer surface of the synthetic rope.

### CROSS-REFERENCE TO RELATED APPLICATION

This application claims the benefit of prior-filed, co-pending U.S. Provisional Patent Application No. 63/588,558, filed Oct. 6, 2023, the entire contents of which are incorporated by reference.

### FIELD

The present disclosure relates to a hoist system for an industrial machine, such as a rope shovel, and more particularly to protection for a hoist rope.

### BACKGROUND

An industrial machine, such as an electric rope shovel for mining, may include a hoist system for lifting a digging attachment.

### SUMMARY

Industrial machines may include hoist systems for articulating or moving a component of the machine.

In one independent aspect, a hoist system is provided for an industrial machine including a digging attachment supported for movement to excavate material. The hoist system includes: a rope attachment device configured to be coupled to the digging attachment; a synthetic rope configured to extend between a hoist drum and the rope attachment device, at least a portion of the synthetic rope configured to be selectively wrapped onto the hoist drum; and a rope protector extending along an outer surface of the synthetic rope.

In some aspects, the rope protector is coupled to a portion of the synthetic rope adjacent the rope attachment device.

In some aspects, the rope protector covers a length of the synthetic rope extending away from the rope attachment device, the length being between approximately 1 foot and approximately 10 feet.

In some aspects, the synthetic rope is a non-homogeneous construction and the rope protector is integrally formed with the synthetic rope, the rope protector including a damge-resistant material braided into a portion of the synthetic rope to form a cover.

In some aspects, the synthetic rope is a non-homogeneous construction and the rope protector is integrally formed with the synthetic rope, the rope protector including a damage-resistant material wound around a portion of the synthetic rope to form an outer jacket layer.

In some aspects, the rope protector is coupled to the rope attachment device and extends around a portion of the synthetic rope.

In some aspects, the rope protector includes at least one of a rubber hose, a steel braided hose, and a wire sleeve.

In some aspects, the rope protector is coupled to a portion of the synthetic rope that engages the rope attachment device.

In some aspects, the rope protector is a metallic tube or pipe.

In some aspects, the hoist system further includes a seal positioned adjacent an end of the rope protector to inhibit ingress of abrasive contaminants.

In some aspects, the hoist system further includes a guide to facilitate a transition of the synthetic rope into or out of the rope protector.

In some aspects, at least a portion of the synthetic rope is coupled to the rope attachment device, wherein the rope protector includes a shield coupled to the rope attachment device and extending around the portion of the synthetic rope coupled to the rope attachment device.

In another independent aspect, a hoist system is provided for an industrial machine including a digging attachment supported for movement to excavate material. The hoist system includes: a rope attachment device configured to be coupled to the digging attachment; a synthetic rope configured to extend between the hoist drum and the rope attachment device, at least a portion of the synthetic rope configured to be selectively wrapped onto the hoist drum; and a first rope protector integrally coupled to a portion of the synthetic rope proximate the rope attachment device.

In some aspects, the hoist system further includes a second rope protector configured to partially surround the synthetic rope proximate the rope attachment device, and wherein the synthetic rope can move relative to the second rope protector.

In some aspects, the first rope protector is flexible and the second rope protector is rigid.

In some aspects, at least part of the first rope protector can be received within the second rope protector.

In yet another independent aspect, a synthetic hoist rope is provided for a hoist system of an industrial machine. The synthetic hoist rope includes: a first end configured to be coupled to a hoist drum of the hoist system; a second end configured to be coupled to the hoist drum of the hoist system; a middle portion configured to be coupled to a rope attachment device; and a rope protector integrally coupled to and circumferentially surrounding at least part of the middle portion.

In some aspects, the rope protector extends a length that is less than 10% of the total length of the synthetic hoist rope.

In some aspects, the taper is configured to prevent ingress of abrasive contaminants between the rope protector and the middle portion.

In some aspects, the rope protector is flexible.

In some aspects, an end of the rope protector has a taper from an outermost surface of the rope protector to an outer surface of the middle portion.

In some aspects, a diameter of the first end is larger than a diameter of the rope protector.

Other aspects of the disclosure will become apparent by consideration of the detailed description and accompanying drawings.

### BRIEF DESCRIPTION OF THE DRAWINGS

FIG. 1 is a perspective view of a rope shovel.

FIG. 2 is a partial perspective view of a portion of a hoist system.

FIG. 3 is a side view of a dipper.

FIG. 4 is partial perspective view of a portion of a hoist system engaging a rope attachment device according to one embodiment.

FIG. 5 is a partial perspective view of a portion of a hoist system engaging a rope attachment device according to another embodiment.

FIG. 6 is a partial perspective view of a portion of a hoist system engaging a rope attachment device according to another embodiment.

FIG. 7 is a partial perspective view of the portion of a hoist system engaging a rope attachment device according to another embodiment.

FIG. 8 is a side view of the portion of the hoist system of FIG. 2.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the present disclosure relates to a hoist system of a rope shovel. The hoist system may include a hoist rope formed from a synthetic material with various features for reducing wear or damage experienced by the rope and other components of the shovel.

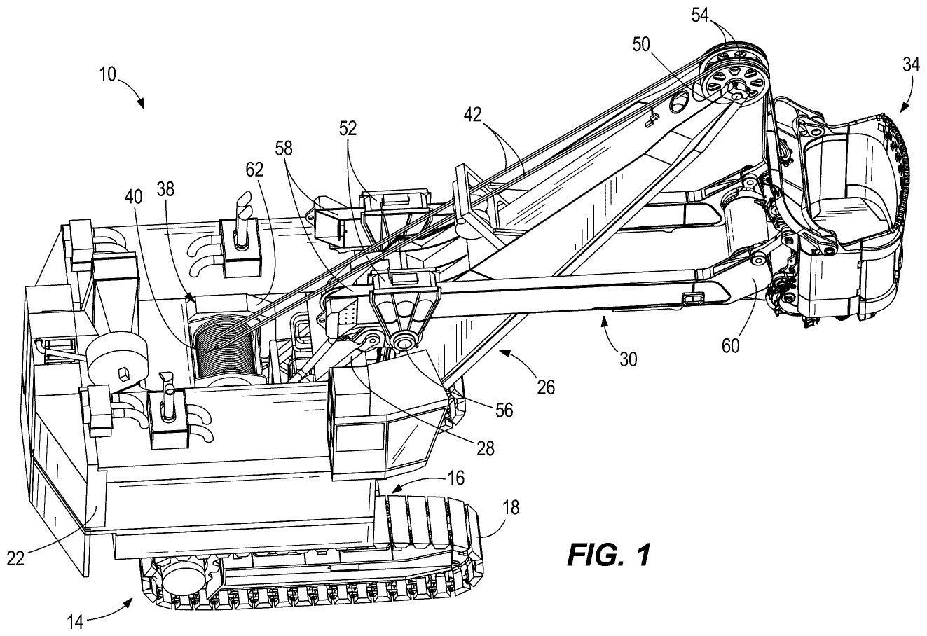

FIG. 1 illustrates an industrial excavating machine such as a rope shovel 10 including a base 14, a boom 26, an elongated member or handle 30, and a digging attachment or dipper 34. The base 14 includes a lower portion 16 supported by traction elements (e.g., crawlers 18) and an upper portion or rotating frame 22 supported for rotation relative to the lower portion 16 about an axis.

The boom 26 includes a first end coupled to the rotating frame 22, and a second end 50 opposite the first end. Boom sheaves 54 are supported adjacent the second end 50 of the boom 26. The boom 26 is pivotable relative to the rotating frame 22 about the first end. In some embodiments, a support member 28 may be coupled between the rotating frame 22 and the boom 26 and may limit pivoting movement of the boom 26 relative to the rotating frame 22. In other embodiments, the boom 26 may be supported by a gantry or other structure. In the illustrated embodiment, saddle blocks 52 and a shipper shaft 56 are supported on the boom 26 between the first end and the second end 50.

The handle 30 is movably coupled to the boom 26 and includes a first end 58 and a second end 60. In the illustrated embodiment, the handle 30 is supported for translational and rotational movement relative to the boom 26 by the shipper shaft 56 and the saddle blocks 52. In the illustrated embodiment, the dipper 34 is fixed to the second end 60 of the handle 30. In other embodiments, the machine 10 includes a bucket that is pivotable relative to the handle 30 about the second end 60. In other embodiments, the handle 30 may be constructed in a different manner and/or may be supported with respect to the boom 26 in a different manner. For example, the handle 30 may be a telescoping member that is pivotally connected to the boom 26 by a yoke, and the handle 30 may be driven to extend and retract by actuation of one or more fluid cylinders or ropes.

The shovel 10 further includes a hoist system 38 for reeling in and paying out a hoist cable or hoist rope 42. The hoist system 38 includes a drum 40 about which a portion of the rope 42 is wrapped. The rope 42 is secured between the drum 40 and the dipper 34, passing over the boom sheave 54. The dipper 34 is raised or lowered relative to the boom sheave 54 as the rope 42 is reeled in or paid out, respectively.

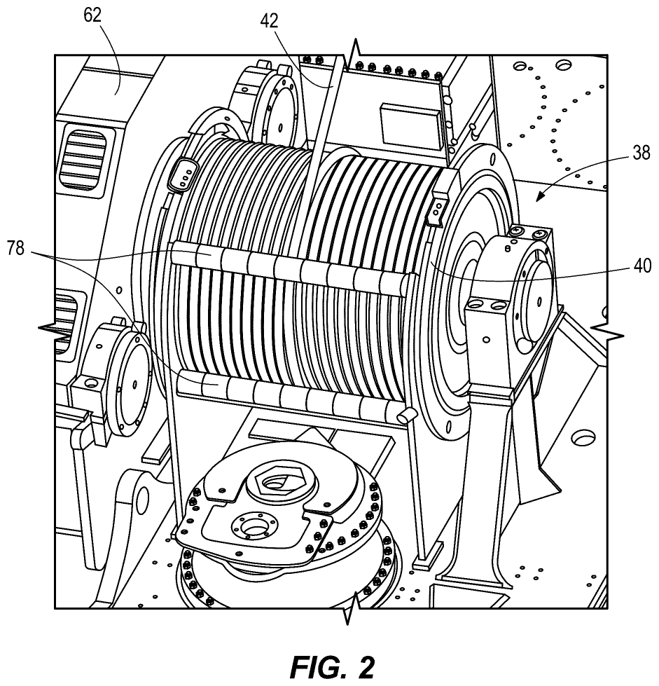

As illustrated in FIGS. 1 and 2, the hoist drive system 38 may include one or more gears that form a gear drive or transmission for driving the drum 40 to take in or let out the rope 42. In the illustrated embodiment, the transmission is supported within a housing of a gear case 62 positioned adjacent an end of the drum 40. The gear case 62 is supported on the rotating frame 22. A tensile force or hoist force is exerted in the rope 42, which extends from the drum 40 to the boom sheave 54 and ultimately to the dipper 34 to raise and lower the dipper 34 (FIG. 1).

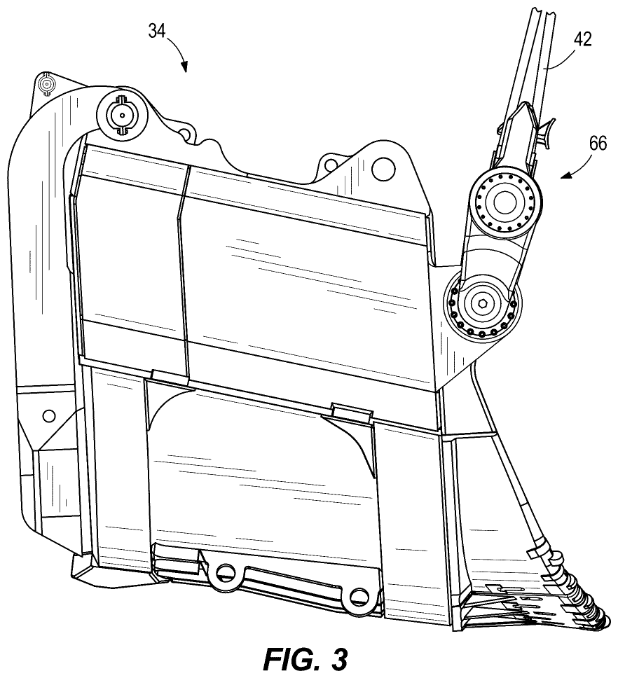

As illustrated in FIG. 3, in some embodiments, a rope attachment device 66 (e.g., an equalizer or a bail) may be coupled to the dipper 34. The rope attachment device 66 can provide a rigid connection between the rope 42 and dipper 34 and maintain clearance between the rope 42 and dipper 34. The rope attachment device 66 can also increase the dig force by applying the tensile force of the rope 42 closer to the digging lip of the dipper 34. In some circumstances, the portion of the rope 42 adjacent the rope attachment device 66 and/or dipper 34 may be more susceptible to wear and/or damage from rock and other debris compared to other portions of the rope 42. Likewise, the engagement of the rope 42 with the rope attachment device 66, and/or dipper 34 can cause excessive abrasion in this area.

In the illustrated embodiments, the hoist rope 42 may be constructed from a synthetic material, such as a polymeric fiber. Replacement/service for conventional hoist ropes can be difficult and time consuming, often requiring handling heavy ropes and unplanned down time. A hoist rope 42 constructed from a synthetic material may have a lifespan that is substantially longer than conventional IWRC (independent wire rope core) steel hoist ropes (e.g., two to three times longer or more), thereby reducing the frequency of replacement/service. In addition, synthetic ropes 42 can be much lighter than conventional hoist ropes and may be easier to install. The lower mass of the synthetic rope 42 may also result in less vibration and damage to auxiliary components due to whipping of the rope 42 or unplanned movements.

The hoist rope 42 may be protected from abrasion and debris, for example, by an abrasion-resistant covering (e.g., a protector or guard 70). As used herein, the term “protector” may refer to a component or structure that provides abrasion resistance to the hoist rope. The term “protector” can refer to a component that is separate from the hoist rope; a component that is integrally attached to an outer surface of the hoist rope; and/or a component that is integrally formed with and/or embedded within the structure of the hoist rope. In some embodiments, the protector may be a separate member that is coupled to the rope 42. In some embodiments, the protector may be a rubber hose, a steel braided hose, or a wire sleeve. In some embodiments, the protector may be formed integrally with the rope 42, or installed directly on the rope 42 during assembly (e.g., prior to installation of the rope terminations). If the protector is a separate component coupled to the rope 42, the protector may closely conform to the outer surface of the rope 42 (for example, the protector may tightly fit around the rope 42) to inhibit debris and contaminants from entering a space between the rope 42 and the protector. In some circumstances, the protector may be loosely fit around the rope 42 and may have sealing provisions 71 at the ends of the protector to inhibit debris and contaminants from entering the space between the rope 42 and the protector. In some embodiments, more than one of the above-referenced options may be used in combination.

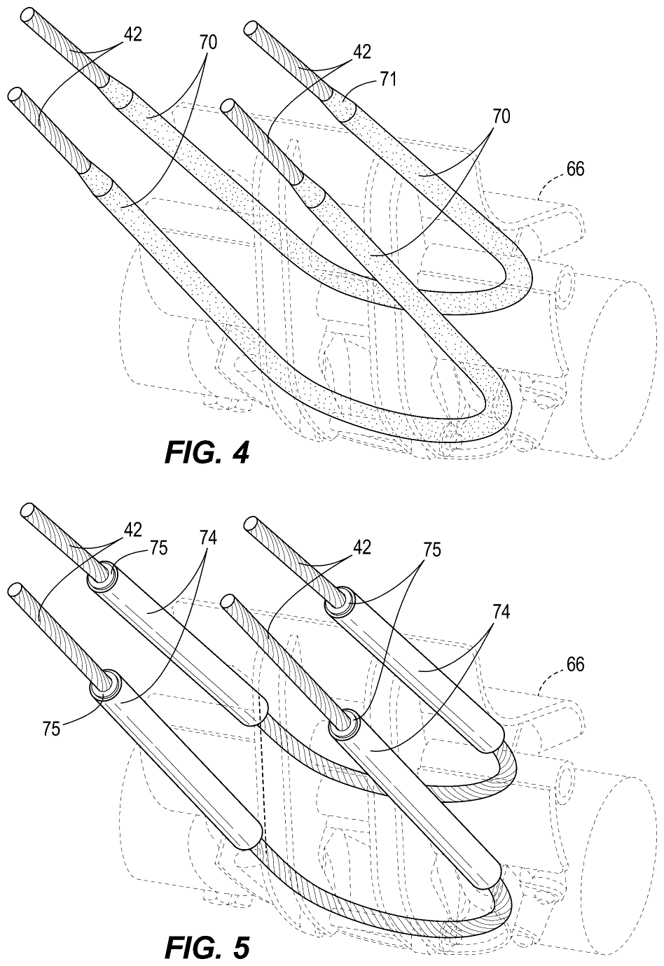

In some circumstances, portions of the rope 42 adjacent the rope attachment device 66 may be more likely to contact debris and therefore may be more likely to experience wear and/or abrasion. As shown in FIG. 4 (in which the rope attachment device 66 is shown as transparent), in some embodiments the covering or protector 70 may be installed around the portions of rope 42 adjacent the rope attachment device 66. For example, the protector 70 may be positioned adjacent the rope attachment device 66 such that an end of the protector 70 may be positioned between approximately one foot to approximately ten feet above the rope attachment device 66. In other embodiments, the protector 70 may extend more than ten feet above the rope attachment device 66. In some embodiments, separate protectors 70 may be coupled to the rope 42 on either side of the rope attachment device 66. In some embodiments, as shown, the protector 70 may extend from one side to the other of the D-block or rope attachment device 66. In some embodiments, the protector 70 may extend along less than 10% of an overall length of rope 42. Positioning the protector 70 only on the portion of rope 42 adjacent the rope attachment device 66 can provide cost and weight saving compared to a protector 70 that extends along a greater length of the rope 42. It also allows a thin hoist rope 42 to more easily wrap around the drum 40, for example, than if the wrapped portion also had a protector 70 or protective member. In some embodiments, an end termination of the rope 42 (e.g., an end termination, such as a ferrule, that couples the rope 42 to the drum 40) may have a larger diameter than the middle portion of the rope 42 (i.e., portion of the rope 42 between end terminations). The protector 70 may have a smaller inner diameter than the end termination of the rope 42. The protector 70 may have a diameter that is larger or approximately equal to the diameter of the middle portion of the rope 42. The protector 70 may be positioned/formed on the portion of the rope 42 during manufacture of the rope 42, before the end terminations are secured to the ends of the rope 42.

As shown in FIG. 5 (in which the rope attachment device 66 is shown as transparent), a protector or guard 74 may be positioned on a portion the rope 42 that engages the rope attachment device 66 (e.g., the portion of the rope 42 that is positioned within a D-block). The protector 74 may be configured to surround and protect the rope 42. For example, the protector 74 may be a rigid member (e.g., a metallic pipe or tube or other covering), and the rope 42 may extend through the rigid member and be protected from debris and damage due to, for example, cutting, abrasion, impact, kinking, and/or material ingress. One or more seals 75 may be positioned where the rope 42 enters the protector 74 to inhibit ingress of abrasive contaminants and debris into the protector 74. In some instances, the rope 42 may be installed within the protector 74 and then a sealant (e.g., caulk, expanding foam, or a similar material) may be applied around the rope 42 to create a seal 75 while still allowing the rope 42 to move. In addition, one or more guides can be positioned adjacent the openings of the protector 74 to assist in the transition of the rope 42 in and out of the protector 74. For example, an end of the protector 74 may include rounded edges or smooth surfaces so that the rope 42 does not wear or catch on the protector 74 as the rope 42 moves relative to the protector 74. The protector 74 may be integrally formed with the rope attachment device 66, or may be separate from the rope attachment device 66 (e.g., may be fastened or coupled to the rope attachment device 66).

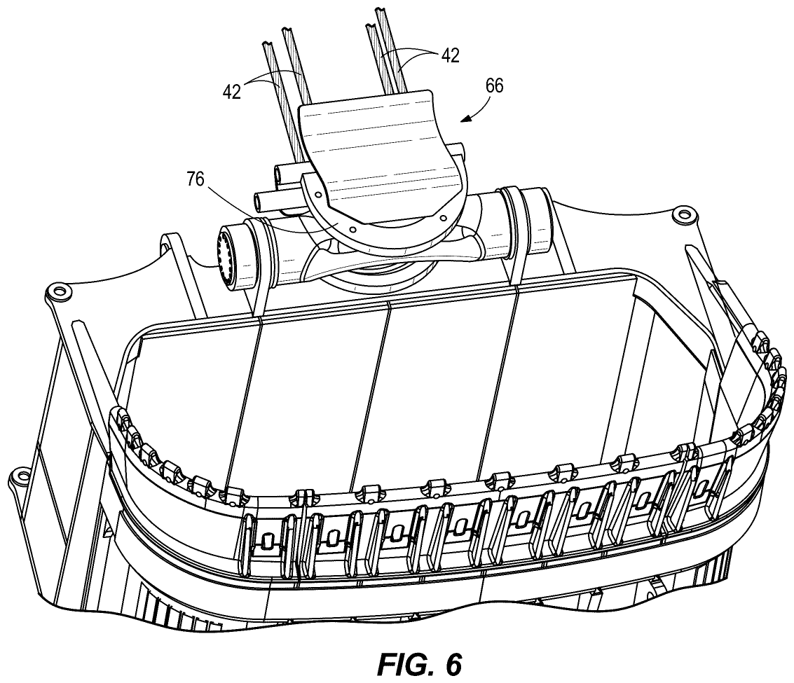

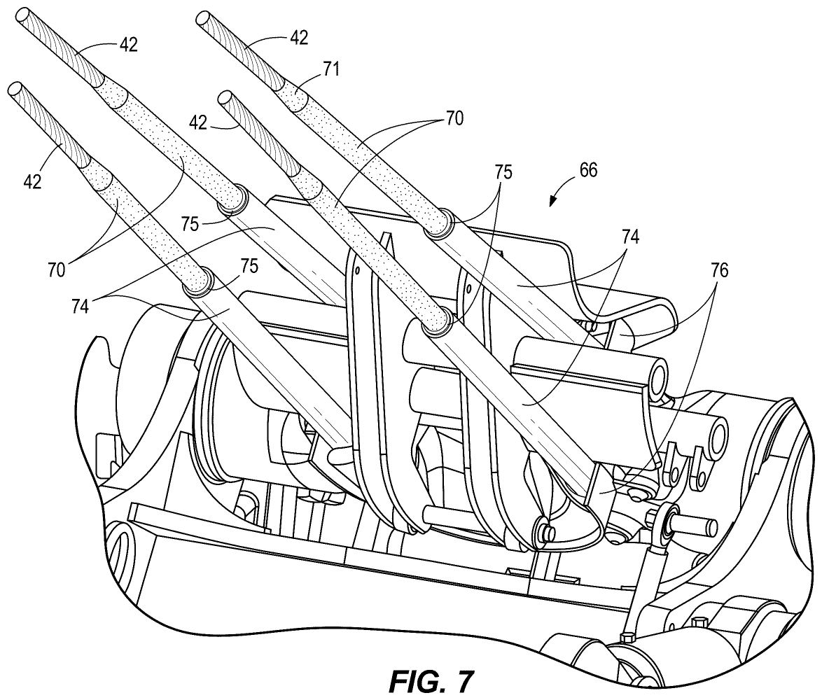

As shown in FIG. 6, a protector or guard 76 may be formed as a shield coupled to the rope attachment device 66 and extending around a portion of the rope 42 that is secured to the rope attachment device 66 (e.g., in a D-block). As shown in FIG. 7, more than one type of the protectors 70, 74, 76 may be used in combination. For example, the protector 74 may protect the rope 42 nearest the rope attachment device 66 while the protector 70 may provide protection for the rope 42 between the rope attachment device 66 and boom sheaves 54, and the guard 76 may provide protection for the portion of the rope 42 in the D-block. In some embodiments, the protector 70 may loosely fit over the rope 42 and maintain a position proximate the protector 74 as the rope 42 moves. The protectors 70, 74, 76 may have different material properties (for example, the protector 74 and guard 76 may have a high hardness and/or rigidity, while the protector 70 may be formed from a material that is flexible and/or lightweight). One or more of the protectors 70, 74, 76 may be coupled together. One or more of the protectors 70, 74, 76 may include sealing members at each corresponding end to prevent ingress of material and debris. For example, the protector 70 may have a taper 71 from its outermost diameter or surface to an outer surface of the rope 42 that can act as a seal.

In some embodiments, the rope 42 may have a non-homogenous construction and may comprise a damage-resistant material braided into or wound around the jacket of the rope 42 to further extend the lifespan of the rope 42. The damage-resistant material may protect against damage due to, for example, cutting, abrasion, impact, kinking, and/or material ingress.

In some embodiments, the rope 42 may have a non-homogenous construction along the length of the rope 42. For example, a section of the rope 42 in the area of the rope attachment device 66 can be subject to less or no bending over boom sheaves 54 and therefore the tensile members of the rope 42 in this section may be reduced while an outer jacket or protective layer of the rope 42 may be increased in thickness. The reduction in tensile members and increase in outer jacket thickness may correspond with each other such that the rope 42 may maintain a constant or near constant outer diameter. Similarly, the construction of the rope 42 may selectively vary throughout the length of the rope 42 to achieve desired load carrying and durability characteristics for separate sections. Sections of rope 42 subject to external damage may have thicker protective layers and/or alternate material construction, while the load carrying members (typically internal to the protective layer(s)) may be reduced, and vice versa for sections of rope 42 not subject to external damage.

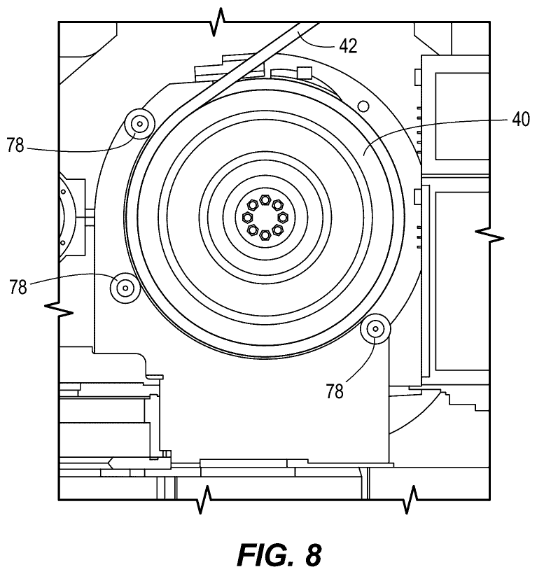

If a rope 42 becomes slack, it may be more likely to whip and hit auxiliary components on the boom 26 and elsewhere. As illustrated in FIGS. 2 and 8, a roller 78 (or multiple rollers 78) may be positioned adjacent the drum 40 to inhibit the rope 42 from creating slack or coming off of the drum 40 to facilitate smoother loading that is less likely to wear the rope 42 than if the rope experience shock loading due to slack or coming away from the drum 40. The rollers 78 may also prevent the rope 42 from jumping or skipping grooves of the drum 40, which can otherwise damage the rope 42. The rollers 78 may be spaced apart from the surface of the drum 40 such that there is minimal clearance, or even a slight interference with the dimension of the rope 42 wrapping around the drum 40. Such interference may provide a “downward” force to keep the rope 42 in contact with the drum 40 at all times. For example, the rollers 78 may be spaced from the surface of the drum 40 on which the rope 42 wraps around approximately a distance that is ¼ the diameter of the rope 42 or less. In such a scenario, the rope 42 may compress between the roller 78 and the wrapping surface of the drum 40 to provide secure engagement. The rollers 78 may have a cylindrical shape. In other embodiments, a concave sheet may extend around a portion of the surface of the drum 40 to assist in retaining the rope 42 against the surface of the drum 40.

In some embodiments, the rope shovel may replace conventional structures with structures formed from a material having a relatively low hardness and/or a geometry that is less likely to cut, catch, or damage a synthetic rope. For example, a conventional rope guide may be replaced with a trough or other guiding structure that allows the rope 42 to fall onto a smooth surface that minimizes wear or catching on the rope 42, while providing a guiding surface. As another example, one or more rollers may be positioned on a rope guide and contact the rope in non-loaded conditions. The rollers 78 may have a large diameter and be made from a non-metallic material.

The foregoing has been described in relation to a rope shovel. It will be apparent to one skilled in the art that the embodiments described herein could likewise be used for other industrial machines. The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

What is claimed is:

1. A hoist system for an industrial machine including a digging attachment supported for movement to excavate material, the hoist system comprising:
a rope attachment device configured to be coupled to the digging attachment;
a synthetic rope configured to extend between a hoist drum and the rope attachment device, at least a portion of the synthetic rope configured to be selectively wrapped onto the hoist drum; and
a rope protector extending along an outer surface of the synthetic rope.

2. The hoist system of claim 1, wherein the rope protector is coupled to a portion of the synthetic rope adjacent the rope attachment device.

3. The hoist system of claim 2, wherein the rope protector covers a length of the synthetic rope extending away from the rope attachment device, the length being between approximately 1 foot and approximately 10 feet.

4. The hoist system of claim 1, wherein the synthetic rope is a non-homogeneous construction and the rope protector is integrally formed with the synthetic rope, the rope protector including a damage-resistant material braided into a portion of the synthetic rope to form an outer jacket layer.

5. The hoist system of claim 1, wherein the synthetic rope is a non-homogeneous construction and the rope protector is integrally formed with the synthetic rope, the rope protector including a damage-resistant material wound around a portion of the synthetic rope to form an outer jacket layer.

6. The hoist system of claim 1, wherein the rope protector is coupled to the rope attachment device and extends around a portion of the synthetic rope.

7. The hoist system of claim 1, wherein the rope protector includes at least one of a rubber hose, a steel braided hose, and a wire sleeve.

8. The hoist system of claim 1, wherein the rope protector is coupled to a portion of the synthetic rope that engages the rope attachment device.

9. The hoist system of claim 1, wherein the rope protector is a metallic tube or pipe.

10. The hoist system of claim 1, further comprising a seal positioned adjacent an end of the rope protector to inhibit ingress of abrasive contaminants.

11. The hoist system of claim 1, further comprising a guide to facilitate a transition of the synthetic rope into or out of the rope protector.

12. The hoist system of claim 1, wherein at least a portion of the synthetic rope is coupled to the rope attachment device, wherein the rope protector includes a shield coupled to the rope attachment device and extending around the portion of the synthetic rope coupled to the rope attachment device.

13. A hoist system for an industrial machine including a digging attachment supported for movement to excavate material, the hoist system comprising:
a rope attachment device configured to be coupled to the digging attachment;
a synthetic rope configured to extend between the hoist drum and the rope attachment device, at least a portion of the synthetic rope configured to be selectively wrapped onto the hoist drum; and
a first rope protector integrally coupled to a portion of the synthetic rope proximate the rope attachment device.

14. The hoist system of claim 13, further comprising a second rope protector configured to partially surround the synthetic rope proximate the rope attachment device, and wherein the synthetic rope can move relative to the second rope protector.

15. The hoist system of claim 14, wherein the first rope protector is flexible and the second rope protector is rigid.

16. The hoist system of claim 15, wherein at least part of the first rope protector can be received within the second rope protector.

17. A synthetic hoist rope for a hoist system of an industrial machine, the synthetic hoist rope comprising:
a first end configured to be coupled to a hoist drum of the hoist system;
a second end configured to be coupled to the hoist drum of the hoist system;
a middle portion configured to be coupled to a rope attachment device; and
a rope protector integrally coupled to and circumferentially surrounding at least part of the middle portion.

18. The synthetic hoist rope of claim 17, wherein the rope protector extends a length that is less than 10% of the total length of the synthetic hoist rope.

19. The synthetic hoist rope of claim 17, wherein the taper is configured to prevent ingress of abrasive contaminants between the rope protector and the middle portion.

20. The synthetic hoist rope of claim 17, wherein the rope protector is flexible.

21. The synthetic hoist rope of claim 17, wherein an end of the rope protector has a taper from an outermost surface of the rope protector to an outer surface of the middle portion.

22. The synthetic hoist rope of claim 17, wherein a diameter of the first end is larger than a diameter of the rope protector.
